(19) United States
(12) Patent Application Publication
(10) Pub. No.: US 2016/0180815 A1
(43) Pub. Date: Jun. 23, 2016

(54) DISPLAY DEVICE AND METHOD OF DRIVING THE SAME

(71) Applicant: Samsung Display Co., Ltd., Yongin-City (KR)

(72) Inventors: Dong-Hak Pyo, Hwaseong-si (KR); Min-Woo Lee, Osan-si (KR)

(21) Appl. No.: 14/709,754

(22) Filed: May 12, 2015

(30) Foreign Application Priority Data
Dec. 18, 2014 (KR) 10-2014-0183455

(51) Int. Cl. G09G 5/18; G09G 5/02; G09G 3/32

(52) U.S. Cl. CPC G09G 5/18; G09G 3/3291; G09G 5/02

(57) ABSTRACT

A display device and a method of driving the same are disclosed. In one aspect, the display device includes an emission duty controller configured to calculate amounts of a plurality of voltage drops at the pixels, generate a plurality of first compensation factors configured to respectively compensate the voltage drops, normalize the first compensation factors so as to generate a plurality of second compensation factors, compensate the image data so as to determine a plurality of emission duties of the pixels, and drive the pixels so as to emit light during a plurality of emission periods respectively corresponding to the emission duties. A driving voltage controller is configured to generate and apply a driving voltage to the display panel, measure a plurality of driving currents of the pixels when the pixels emit light, and control a voltage level of the driving voltage.

### INCORPORATION BY REFERENCE TO ANY PRIORITY APPLICATIONS

This application claims priority under 35 USC §119 to Korean Patent Application No. 10-2014-0183455, filed on Dec. 18, 2014 in the Korean Intellectual Property Office (KIPO), the contents of which are incorporated herein in its entirety by reference.

### BACKGROUND

1. Field

The described technology generally relates to a display device and a method of driving the display device.

2. Description of the Related Technology

A display device includes pixels that receive a driving voltage and a data signal. For example, in an organic light-emitting diode (OLED) display, each of the pixels generates a driving current based on the driving voltage and the data signal. Each of the pixels emits light based on the driving current.

Voltage drops (e.g., IR-drop) across wires (e.g., power supply lines) supplying the driving voltage can cause a voltage deviation of the driving voltage at the display pixels. Moreover, the luminance characteristics of the pixels differ according to the manufacturing environment, variation in the materials, etc. As a result, the luminance of light emitted from the pixels will vary and thus be non-uniform among the pixels, although the pixels receive the same data signal.

### SUMMARY OF CERTAIN INVENTIVE ASPECTS

One inventive aspect relates to a display device that substantially uniforms luminance of light and prevents distortion of color coordinates of emitted light and a method of driving the display device.

Another aspect is a display device that includes a display panel including a plurality of pixels, an emission duty controller configured to calculate amounts of voltage drops at the pixels based on image data, to generate first compensation factors that compensate the voltage drops based on the amounts of the voltage drops, to normalize the first compensation factors to generate second compensation factors, to compensate the image data based on the second compensation factors to determine emission duties of the pixels, and to drive the pixels for emitting light during emission periods that correspond to the emission duties, each of the emission duties being a ratio of a time period for emitting light in one frame, and a driving voltage controller configured to generate a driving voltage for applying to the display panel, to measure driving currents of the pixels that are generated when the pixels emit light based on the driving voltage, and to control a voltage level of the driving voltage based on the driving currents.

In example embodiments, the emission duty controller divides the first compensation factors by a maximum value of the first compensation factors to generate the second compensation factors.

In example embodiments, the emission duty controller includes a panel load calculator configured to calculate a panel load of the display panel based on the image data, a voltage drop calculator configured to calculate the amounts of the voltage drops based on the panel load, a compensation factor generator configured to generate the first compensation factors based on the amounts of the voltage drops and to generate the second compensation factors based on the first compensation factors, a compensator configured to compensate the image data based on the second compensation factors to determine the emission duties, and a display panel driver configured to apply data signals, which control the emission periods according to the emission duties, to the pixels.

In example embodiments, the driving voltage controller includes a target driving current calculator configured to calculate a target driving current according to the panel load, the target driving current being a targeted sum of the driving currents to be flowed into the pixels according to the panel load, a driving current controller configured to measure the driving currents, to calculate a sum of the driving currents of the pixels, and to generate a driving voltage control signal based on a difference between the sum of driving currents and the target driving current, and a voltage generator configured to generate the driving voltage for applying to the display panel and to control the voltage level of the driving voltage based on the driving voltage control signal.

In example embodiments, the voltage drop calculator calculates the amounts of the voltage drops based on the panel load and locations of the pixels.

In example embodiments, the voltage drop calculator calculates increased amounts of the voltage drops as the panel load increases, and the voltage drop calculator calculates decreased amounts of the voltage drops as the panel load decreases.

In example embodiments, the compensation factor generator generates increased first compensation factors as the amounts of the voltage drops increase, and the compensation factor generator generates decreased first compensation factors as the amounts of the voltage drops decrease.

In example embodiments, the compensation factor generator generates the first compensation factors based on the amounts of the voltage drops and luminance of light emitted from the pixels.

In example embodiments, the compensation factor generator generates the first compensation factors and the second compensation factors every frame.

In example embodiments, the compensation factor generator calculates applied voltages that are voltage differences between the driving voltage and the amounts of the voltage drops and calculates the first compensation factors based on the applied voltages.

In example embodiments, the compensation factor generator includes an applied voltage calculator configured to calculate the applied voltages, a first compensation factor generator configured to calculate the first compensation factors based on the applied voltages, and a second compensation factor generator configured to normalize the first compensation factors to generate second compensation factors.

In example embodiments, the compensator multiplies the image data by the second compensation factors to compensate the image data.

In example embodiments, the display device further includes a gamma generator configured to perform a gamma compensation of the image data by using a gamma curve.

In example embodiments, the gamma generator includes a gamma register configured to store the gamma curve and a gamma compensator configured to read the gamma curve from the gamma register and to compensate the image data based on the read gamma curve.

In example embodiments, the display panel driver includes a scan driver configured to generate scan signals and a data driver configured to generate the data signals, and the pixels receives the data signals during the scan signals being activated.

In example embodiments, the display device further includes a timing controller configured to control the display panel driver.

In example embodiments, the target driving current calculator generates a scale factor corresponding to the panel load based on a predetermined power control curve and apply the scale factor to the panel load to calculate the target driving current.

In example embodiments, the target driving current calculator includes a memory configured to store the power control curve, a scale factor generator configured to read the power control curve from the memory and to generate the scale factor based on the power control curve, and a scaler configured to apply the scale factor to the panel load to calculate the target driving current.

Another aspect is a method for driving a display device including a plurality of pixels that includes an operation of calculating amounts of voltage drops at the pixels based on image data, an operation of generating first compensation factors that compensate the voltage drops based on the amounts of the voltage drops, an operation of normalizing the first compensation factors to generate second compensation factors, an operation of compensating the image data based on the second compensation factors to determine emission duties of the pixels, each of the emission duties being a ratio of a time period for emitting light in one frame, an operation of driving the pixels for emitting light during emission periods that correspond to the emission duties, an operation of measuring driving currents of the pixels that are generated when the pixels emit light based on a driving voltage that is generated for applying to a display panel, and an operation of controlling a voltage level of the driving voltage based on the driving currents.

In example embodiments, the operation of generating the second compensation factors includes an operation of dividing the first compensation factors by a maximum value of the first compensation factors.

Another aspect is a display device comprising: a display panel including a plurality of pixels; an emission duty controller configured to i) calculate amounts of a plurality of voltage drops at the pixels based on image data, ii) generate a plurality of first compensation factors configured to respectively compensate the voltage drops, iii) normalize the first compensation factors so as to generate a plurality of second compensation factors, iv) compensate the image data based on the second compensation factors so as to determine a plurality of emission duties of the pixels, and v) drive the pixels so as to emit light during a plurality of emission periods respectively corresponding to the emission duties, wherein one of the emission periods and a non-emission period constitutes a frame period, and wherein each of the emission duties represents a ratio of the corresponding emission period to the corresponding frame period; and a driving voltage controller configured to generate and apply a driving voltage to the display panel, measure a plurality of driving currents of the pixels when the pixels emit light based on the driving voltage, and control a voltage level of the driving voltage based on the driving currents.

In the above display device, the emission duty controller is further configured to divide the first compensation factors by a maximum value of the first compensation factors so as to generate the second compensation factors.

In the above display device, the emission duty controller includes: a panel load calculator configured to calculate a panel load of the display panel based on the image data; a voltage drop calculator configured to calculate the amounts of the voltage drops based on the panel load; a compensation factor generator configured to generate the first compensation factors based on the amounts of the voltage drops and generate the second compensation factors based on the first compensation factors; a compensator configured to compensate the image data based on the second compensation factors so as to determine the emission duties; and a display panel driver configured to apply a plurality of data signals to the pixels, wherein the data signals are configured to control the emission periods based on the emission duties.

In the above display device, the driving voltage controller includes: a target driving current calculator configured to calculate a target driving current based on the panel load, wherein the target driving current includes a targeted sum of the driving currents to be flowed into the pixels based on the panel load; a driving current controller configured to measure the driving currents, calculate the sum of the driving currents of the pixels, and generate a driving voltage control signal based on the difference between the sum of driving currents and the target driving current; and a voltage generator configured to i) generate and apply the driving voltage to the display panel and ii) control a voltage level of the driving voltage based on the driving voltage control signal.

In the above display device, the voltage drop calculator is further configured to calculate the amounts of the voltage drops based on the panel load and locations of the pixels.

In the above display device, the voltage drop calculator is further configured to calculate i) increased amounts of the voltage drops as the panel load increases and ii) decreased amounts of the voltage drops as the panel load decreases.

In the above display device, the compensation factor generator is further configured to increase the first compensation factors as the amounts of the voltage drops increase and decrease the first compensation factors as the amounts of the voltage drops decrease.

In the above display device, the compensation factor generator is further configured to generate the first compensation factors based on the amounts of the voltage drops and luminance of light emitted from the pixels.

In the above display device, the compensation factor generator is further configured to generate the first and second compensation factors every frame.

In the above display device, the compensation factor generator is further configured to calculate voltage differences between the driving voltage and the amounts of the voltage drops as applied voltages and calculate the first compensation factors based on the applied voltages.

In the above display device, the compensation factor generator includes: an applied voltage calculator configured to calculate the applied voltages; a first compensation factor generator configured to calculate the first compensation factors based on the applied voltages; and a second compensation factor generator configured to normalize the first compensation factors so as to generate second compensation factors.

In the above display device, the compensator is further configured to multiply the image data by the second compensation factors so as to compensate the image data.

The above display device further comprises a gamma generator configured to perform a gamma compensation of the image data based on a gamma curve.

In the above display device, the gamma generator includes: a gamma register configured to store the gamma curve; and a gamma compensator configured to read the gamma curve from the gamma register and compensate the image data based on the read gamma curve.

In the above display device, the display panel driver includes: a scan driver configured to generate a plurality of scan signals; and a data driver configured to generate the data signals, wherein the pixels are configured to receive the data signals while the scan signals are activated.

The above display device further comprises a timing controller configured to control the display panel driver.

In the above display device, the target driving current calculator is further configured to generate a scale factor corresponding to the panel load based on a predetermined power control curve and apply the scale factor to the panel load so as to calculate the target driving current.

In the above display device, the target driving current calculator includes: a memory configured to store the power control curve; a scale factor generator configured to read the power control curve from the memory and generate the scale factor based on the power control curve; and a scaler configured to apply the scale factor to the panel load to calculate the target driving current.

Another aspect is a method of driving a display device including a plurality of pixels, comprising: calculating amounts of a plurality of voltage drops at the pixels based on image data; generating a plurality of first compensation factors configured to respectively compensate the voltage drops based on the amounts of the voltage drops; normalizing the first compensation factors so as to generate a plurality of second compensation factors; compensating the image data based on the second compensation factors so as to determine a plurality of emission duties of the pixels; driving the pixels so as to emit light during the emission periods, wherein one of the emission periods and a non-emission period constitute a frame period, and wherein each of the emission duties represents a ratio of the corresponding emission period to the corresponding frame period; generating and applying a driving voltage to a display panel; measuring driving currents of the pixels when the pixels emit light based on the driving voltage; and controlling a voltage level of the driving voltage based on the driving currents.

In the above method, generating the second compensation factors includes dividing the first compensation factors by a maximum value of the first compensation factors.

According to at least one of the disclosed embodiments, the display device and the method of driving the display device compensate image data based on the second compensation factors so that the luminance of light emitted from the pixels is uniform. In addition, the display device and the method of driving the display device according to example embodiments normalize the first compensation factors so that the distortion of the color coordinates of emitted light can be prevented.

### BRIEF DESCRIPTION OF THE DRAWINGS

FIG. 1 is a block diagram illustrating a display device according to example embodiments.

FIG. 2 is a block diagram illustrating an example of the display device of FIG. 1.

FIG. 3 is a block diagram illustrating an example of a compensation factor generator included in the display device of FIG. 2.

FIG. 4 is a block diagram illustrating an example of a target driving current calculator included in the display device of FIG. 2.

FIG. 5 is a block diagram illustrating an example of a gamma generator included in the display device of FIG. 2.

FIG. 6 is a block diagram illustrating an example of a display panel driver included in the display device of FIG. 2.

FIG. 7 is a flowchart illustrating a method of driving a display device according to example embodiments.

### DETAILED DESCRIPTION OF CERTAIN EMBODIMENTS

The display device can be designed to control the driving voltage and the data signal to normalize the luminance of the emitted light. However, when a panel load of driving currents flowing into the display panel changes rapidly, the difference between the changing speed of the driving voltage and the controlling speed of the data signal can increase. As a result, color coordinates of emitted light will be distorted.

Hereinafter, embodiments of the described technology will be explained in detail with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

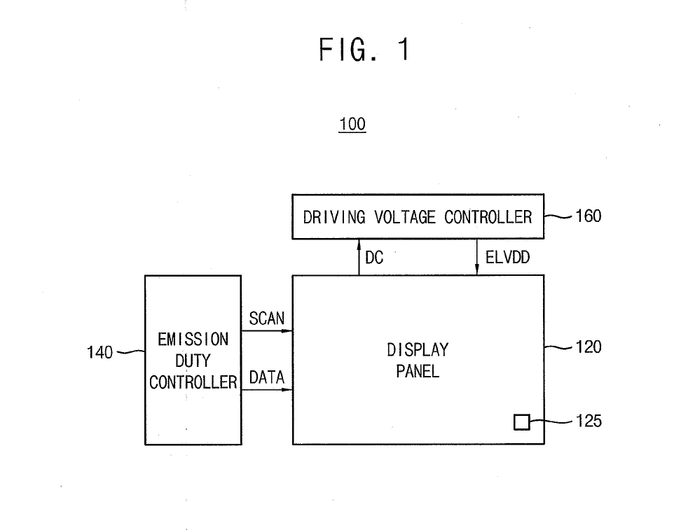

Referring to FIG. 1, the display device 100 includes a display panel 120, an emission duty controller 140, and a driving voltage controller 160. In some embodiments, the display device 100 further includes a gamma generator. In some embodiments, the display device 100 further includes a timing controller.

The display panel 120 can include a plurality of pixels 125. The pixels 125 can generate light having luminance that is substantially proportional to a product of an emission period corresponding to each of emission duties and a driving current generated based on a driving voltage ELVDD. Here, each of the emission duties can be a ratio of a time period for emitting light in one frame. In a digital driving technique, the pixels 125 can implement grayscales based on the total amount of emission periods within one frame period. For example, one frame includes a plurality of subframes. The pixels 125 can selectively emit light from each of the subframes, so that the pixels 125 can implement the grayscales based on the total amount of emission periods of the subframes.

Each of the pixels 125 can generate the driving current based on the driving voltage. Each of the pixels 125 can include a light emitting element that emits light based on the driving current. In general, the light emitting element can emit light having luminance substantially proportional to the driving current. For example, each of the pixels 125 included in an OLED display includes an OLED as the light emitting element. The organic light emitting device can emit light having luminance substantially proportional to an amount of the driving current. Therefore, the pixels 125 receiving various levels of driving voltages ELVDD can emit light having various luminance. As a result, each of the pixels 125 receiving the different driving voltages ELVDD can implement different grayscales as each other, although the pixels 125 have substantially the same emission duties. Hence, luminance of light emitted from the pixels 125 can be substantially proportional to a product of the emission period corresponding to each of the emission duties and the driving current.

The emission duty controller 140 can determine the emission duties of the pixels 125. The emission duty controller 140 can generate data signals DATA based on the emission duties. The emission duty controller 140 can apply the data signals DATA to target pixels that receive activated scan signals SCAN among the pixels 125.

The emission duty controller 140 can calculate amounts of voltage drops at the pixels 125 based on image data. In some embodiments, the emission duty controller 140 calculates the amounts of the voltage drops based on a panel load of the display panel 120. The sum of the driving currents flowing into the display panel 120 increases as the panel load increases, so that the amounts of the voltage drops can increase. The emission duty controller 140 can include a memory that stores a resistance value which each of voltage supplying lines connected to the pixels 125 has. Therefore, the emission duty controller 140 can calculate the amounts of the voltage drops at the pixels 125 based on the panel load and the resistance value which is read from the memory and each of the voltage supplying lines has.

The emission duty controller 140 can generate first compensation factors that compensate the voltage drops based on the amounts of the voltage drops. The driving currents can decrease as the driving voltage ELVDD decreases. Thus, luminance of light emitted from the pixels 125 can decrease. Therefore, the emission duty controller 140 can increase the emission duties of the pixels 125 in response to decreased amount of the driving voltage ELVDD to compensate the voltage drops. For example, the emission duty controller 140 divides an original target luminance value (e.g., L0) by a luminance value (e.g., L) that is decreased by the voltage drops to generate the first compensation factors (e.g., L0/L). In this case, the emission duty controller 140 can compensate the voltage drops based on the first compensation factors that are greater than a predetermined value. Here, an overflow of the pixel can occur as the emission duty controller 140 excessively increases the emission duties. As a result, color coordinates of light emitted from the pixels can be distorted.

The emission duty controller 140 can normalize the first compensation factors to generate second compensation factors. In this case, the emission duties are not excessively increased. In some embodiments, the emission duty controller 140 divides the first compensation factors by a maximum value of the first compensation factors to generate the second compensation factors. Here, a maximum value of the second compensation factors can be 1.

The emission duty controller 140 can compensate the image data based on the second compensation factors to determine emission duties of the pixels 125. For example, the emission duty controller 140 multiplies the image data by the second compensation factors to compensate the image data.

The emission duty controller 140 can drive the pixels 125 for emitting light during emission periods that correspond to the emission duties. Each of the emission duties can be a ratio of a time period for emitting light in one frame.

In some embodiments, the emission duty controller 140 includes a panel load calculator, a voltage drop calculator, a compensation factor generator, a compensator, and a display panel driver. The panel load calculator can calculate the panel load of the display panel 120 based on the image data. The panel load can be substantially proportional to the sum of the driving currents flowing into the display panel 120. The panel load calculator can calculate the sum of the driving currents based on the image data.

The voltage drop calculator can calculate the amounts of the voltage drops based on the panel load. In some embodiments, the voltage drop calculator calculates the amounts of the voltage drops based on the panel load and locations of the pixels. In some embodiments, the voltage drop calculator calculates increased amounts of the voltage drops as the panel load increases, and the voltage drop calculator calculates decreased amounts of the voltage drops as the panel load decreases. For example, the amounts of the voltage drops increases as the panel load increases and decreases as the panel load decreases.

The compensation factor generator can generate the first compensation factors based on the amounts of the voltage drops and generate the second compensation factors based on the first compensation factors. In some embodiments, the compensation factor generator generates increased first compensation factors as the amounts of the voltage drops increase, and the compensation factor generator generates decreased first compensation factors as the amounts of the voltage drops decrease. For example, the first compensation factors increase as the amounts of the voltage drops increases and decrease as the amounts of the voltage drops decreases. In some embodiments, the compensation factor generator generates the first compensation factors based on the amounts of the voltage drops and luminance of light emitted from the pixels. In some embodiments, the compensation factor generator generates the first compensation factors and the second compensation factors every frame.

In some embodiments, the compensation factor generator calculates applied voltages that are voltage differences between the driving voltage and the amounts of the voltage drops. Here, the applied voltages can mean voltages that are actually applied to the pixels. Also, the compensation factor generator can calculate the first compensation factors based on the applied voltages.

In some embodiments, the compensation factor generator includes an applied voltage calculator, a first compensation factor generator, and a second compensation factor generator. The applied voltage calculator can calculate the applied voltages. The first compensation factor generator can calculate the first compensation factors based on the applied voltages. The second compensation factor generator can normalize the first compensation factors to generate second compensation factors.

The compensator can compensate the image data based on the second compensation factors to determine the emission duties. In some embodiments, the compensator multiplies the image data by the second compensation factors to compensate the image data.

The display panel driver, which can control the emission periods according to the emission duties, can apply data signals DATA to the pixels 125. In some embodiments, the display panel driver includes a scan driver and a data driver. The scan driver can generate the scan signals SCAN. The data driver can generate the data signals DATA. The pixels 125 can receive the data signals DATA during the scan signals SCAN being activated. In some embodiments, the timing controller controls the display panel driver.

The driving voltage controller 160 can generate the driving voltage ELVDD for applying to the display panel 120. The driving voltage controller 160 can measure driving currents that are generated during the emission periods corresponding to the emission duties and based on the driving voltage ELVDD. The driving voltage controller 160 can control a voltage level of the driving voltage ELVDD based on the driving currents. For example, the driving voltage controller 160 compares the sum of the measured driving currents with a targeted (of an expected) sum of the driving currents and control the voltage level of the driving voltage ELVDD based on the difference between the sum of the measured driving currents and the targeted sum of the driving currents.

The driving voltage controller 160 can include a target driving current calculator, a driving current controller, and a voltage generator.

The target driving current calculator can calculate a target driving current according to the panel load. The target driving current is a targeted (or an expected) sum of the driving currents to be flowed into the pixels according to the panel load. In some embodiments, the target driving current calculator includes a memory, a scale factor generator, and a scaler. The memory can store the power control curve. The scale factor generator can read the power control curve from the memory and generate the scale factor based on the power control curve. The scaler can apply the scale factor to the panel load to calculate the target driving current.

The driving current controller can measure the driving currents and calculate the sum of the driving currents of the pixels. The driving current controller can generate a driving voltage control signal based on the difference between the sum of driving currents and the target driving current.

The voltage generator can generate the driving voltage ELVDD for applying to the display panel 120 and control the voltage level of the driving voltage ELVDD based on the driving voltage control signal.

The gamma generator can perform a gamma compensation of the image data by using a gamma curve. In some embodiments, the gamma generator includes a gamma register and a gamma compensator. The gamma register can store the gamma curve. The gamma compensator can read the gamma curve from the gamma register and compensate the image data based on the read gamma curve. For example, the gamma generator performs the gamma compensation according to the gamma curve having a gamma value of about 2.2.

As described above, the emission duty controller 140 can compensate the image data based on the second compensation factors so that the luminance of light emitted from the pixels can be uniform. Moreover, in some embodiments, the emission duty controller 140 normalizes the first compensation factors so that color coordinates of emitted light are not distorted.

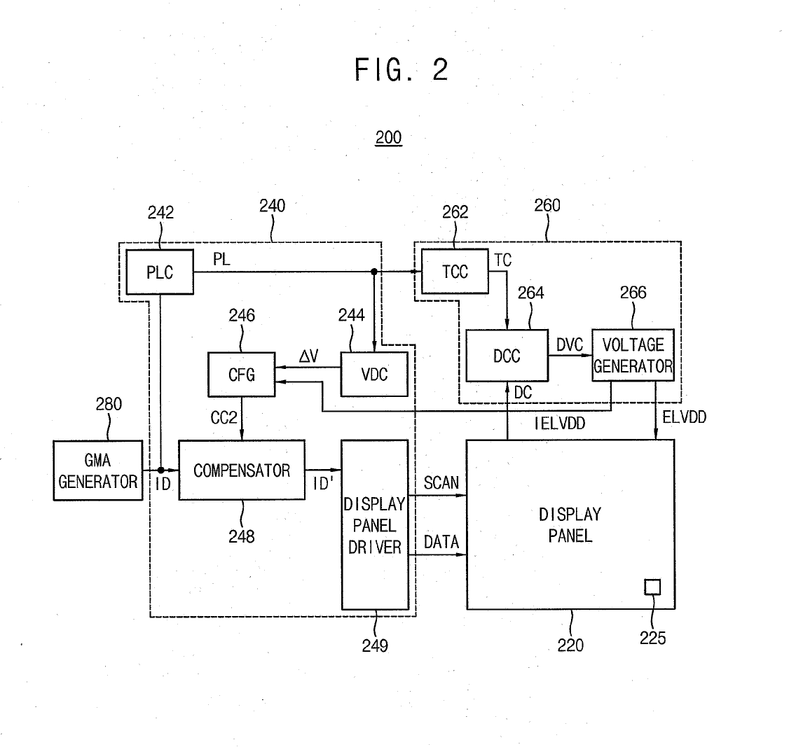

FIG. 2 is a block diagram illustrating an example of the display device of FIG. 1.

Referring to FIG. 2, the display device 200 includes a display panel 220, an emission duty controller 240, and a driving voltage controller 260. In some embodiments, the display device 200 further includes a gamma generator 280.

The display panel 220 can include a plurality of pixels 225. The pixels 225 can generate light having luminance that is substantially proportional to a product of an emission period corresponding to each of emission duties and a driving current generated based on a driving voltage ELVDD.

The emission duty controller 240 can determine the emission duties of the pixels 225. The emission duty controller 240 can generate data signals DATA based on the emission duties. The emission duty controller 240 can apply the data signals DATA to target pixels that receive activated scan signals SCAN among the pixels 225.

The emission duty controller 240 can include a panel load calculator 242, a voltage drop calculator 244, a compensation factor generator 246, a compensator 248, and a display panel driver 249.

The panel load calculator 242 can calculate the panel load PL of the display panel 220 based on the image data ID. The panel load PL can be substantially proportional to the sum of the driving currents flowing into the display panel 220. The panel load calculator 242 can calculate the sum of the driving currents based on the image data ID.

The voltage drop calculator 244 can calculate the amounts of the voltage drops ΔV based on the panel load PL. In some embodiments, the voltage drop calculator 244 calculates the amounts of the voltage drops ΔV based on the panel load PL and locations of the pixels 225. In some embodiments, the voltage drop calculator 244 calculates increased amounts of the voltage drops ΔV as the panel load PL increases, and the voltage drop calculator calculates decreased amounts of the voltage drops ΔV as the panel load PL decreases. For example, the amounts of the voltage drops ΔV increase as the panel load PL increases and decrease as the panel load PL decreases.

The compensation factor generator 246 can generate the first compensation factors based on the amounts of the voltage drops ΔV and generate the second compensation factors CC2 based on the first compensation factors. In some embodiments, the compensation factor generator 246 generates increased first compensation factors as the amounts of the voltage drops ΔV increase, and the compensation factor generator generates decreased first compensation factors as the amounts of the voltage drops ΔV decrease. For example, the first compensation factors increase as the amounts of the voltage drops ΔV increases and decrease as the amounts of the voltage drops ΔV decreases. In some embodiments, the compensation factor generator 246 generates the first compensation factors based on the amounts of the voltage drops and luminance of light emitted from the pixels. In some embodiments, the compensation factor generator 246 generates the first compensation factors and the second compensation factors CC2 every frame.

In some embodiments, the compensation factor generator 246 calculates applied voltages that are voltage differences between the driving voltage ELVDD and the amounts of the voltage drops ΔV. Here, the applied voltages can mean voltages that are actually applied to the pixels 225. Therefore, the compensation factor generator 246 can calculate applied voltages based on driving voltage information IELVDD from a voltage generator 266 and the amounts of the voltage drops ΔV. Also, the compensation factor generator 246 can calculate the first compensation factors based on the applied voltages.

In some embodiments, the compensation factor generator 246 includes an applied voltage calculator, a first compensation factor generator, and a second compensation factor generator. The applied voltage calculator can calculate the applied voltages. The first compensation factor generator can calculate the first compensation factors based on the applied voltages. The second compensation factor generator can normalize the first compensation factors to generate second compensation factors CC2.

The compensator 248 can compensate the image data ID based on the second compensation factors CC2 to determine the emission duties. In some embodiments, the compensator 248 multiplies the image data ID by the second compensation factors CC2 to generate compensated image data ID′.

The display panel driver 249, which can control the emission periods according to the emission duties, can apply data signals DATA to the pixels 225. In some embodiments, the display panel driver 249 includes a scan driver and a data driver. The scan driver can generate the scan signals SCAN. The data driver can generate the data signals DATA. The pixels 225 can receive the data signals DATA during the scan signals SCAN being activated. In some embodiments, the timing controller controls the display panel driver 249.

The driving voltage controller 260 can include a target driving current calculator 262, a driving current controller 264, and a voltage generator 266.

The target driving current calculator 262 can calculate a target driving current TC according to the panel load PL. The target driving current TC is a targeted sum of the driving currents to be flowed into the pixels 225 according to the panel load PL. In some embodiments, the target driving current calculator 262 includes a memory, a scale factor generator, and a scaler. The memory can store the power control curve. The scale factor generator can read the power control curve from the memory and generate the scale factor based on the power control curve. The scaler can apply the scale factor to the panel load PL to calculate the target driving current TC.

The driving current controller 264 can measure the driving currents DC and calculate the sum of the driving currents of the pixels 225. The driving current controller 264 can generate a driving voltage control signal DVC based on the difference between the sum of driving currents and the target driving current TC.

The voltage generator 266 can generate the driving voltage ELVDD for applying to the display panel 220 and control the voltage level of the driving voltage ELVDD based on the driving voltage control signal DVC. Also, the voltage generator 266 can supply the driving voltage information IELVDD to the compensation factor generator 246.

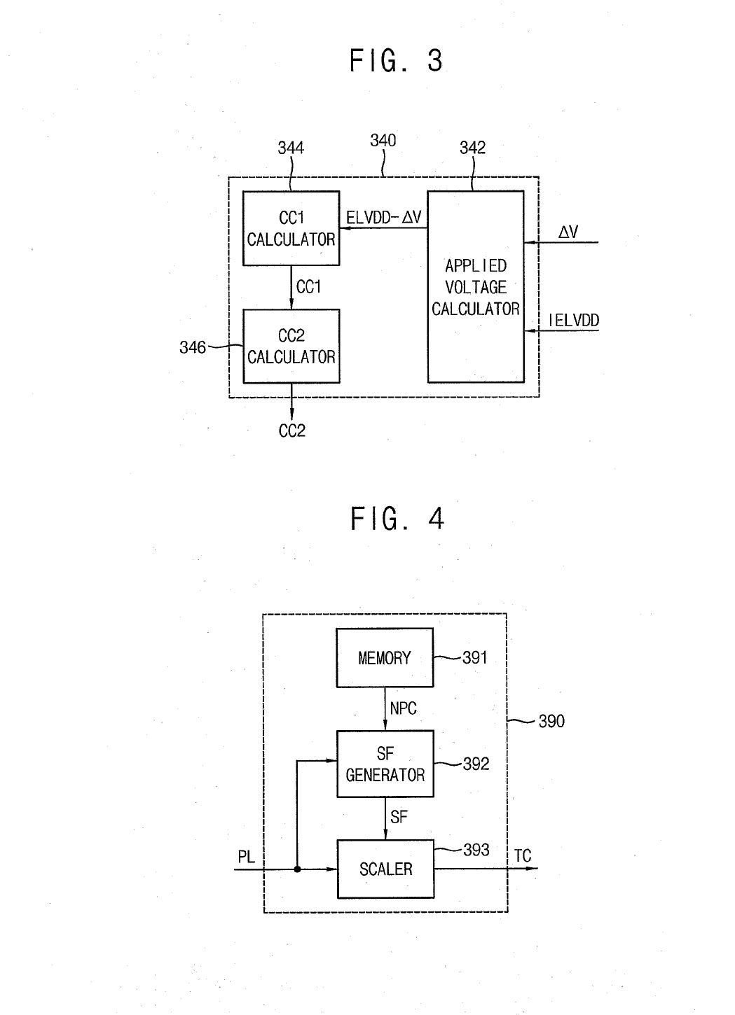

FIG. 3 is a block diagram illustrating an example of a compensation factor generator included in the display device of FIG. 2.

Referring to FIG. 3, the compensation factor generator 340 includes an applied voltage calculator 342, a first compensation factor generator 344, and a second compensation factor generator 346. The applied voltage calculator 342 can calculate the applied voltages (i.e., ELVDD-ΔV) based on driving voltage information IELVDD and amounts of the voltage drops ΔV. The first compensation factor generator 344 can calculate the first compensation factors CC1 based on the applied voltages ELVDD-ΔV. The second compensation factor generator 346 can normalize the first compensation factors CC1 to generate second compensation factors CC2.

FIG. 4 is a block diagram illustrating an example of a target driving current calculator included in the display device of FIG. 2.

Referring to FIG. 4, the target driving current calculator 390 includes a memory 391, a scale factor generator 392, and a scaler 393. The memory 391 can store the power control curve NPC. The scale factor generator 392 can read the power control curve NPC from the memory 391 and generate the scale factor SF based on the power control curve NPC. The scaler 393 can apply the scale factor SF to the panel load PL to calculate the target driving current TC.

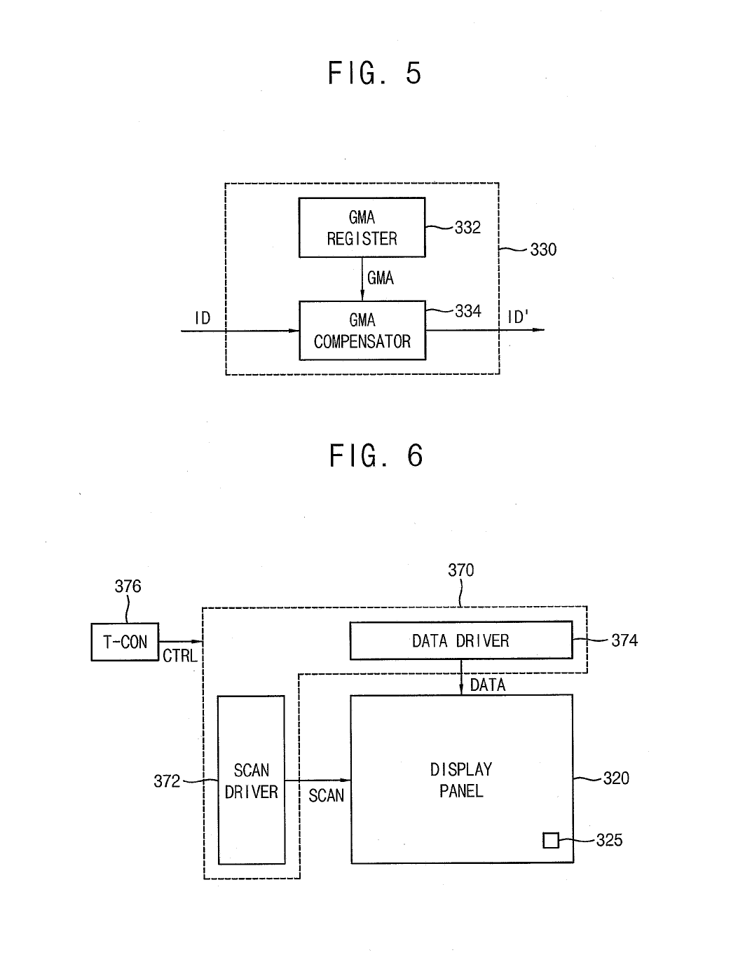

FIG. 5 is a block diagram illustrating an example of a gamma generator included in the display device of FIG. 2.

Referring to FIG. 5, the gamma generator 330 includes a gamma register 332 and a gamma compensator 334. The gamma register 332 can store the gamma curve GMA. The gamma compensator 334 can read the gamma curve GMA from the gamma register 332 and compensate the image data ID based on the gamma curve GMA. The gamma compensator 334 can generate compensated image data ID′.

FIG. 6 is a block diagram illustrating an example of a display panel driver included in the display device of FIG. 2.

Referring to FIG. 6, the display panel driver 370 includes a scan driver 372 and a data driver 374. The scan driver 372 can generate the scan signals SCAN. The data driver 374 can generate the data signals DATA. The pixels 325 included in a display panel 320 can receive the data signals DATA during the scan signals SCAN being activated. A timing controller 376 can control the display panel driver 370 based on a panel driver control signal CTRL.

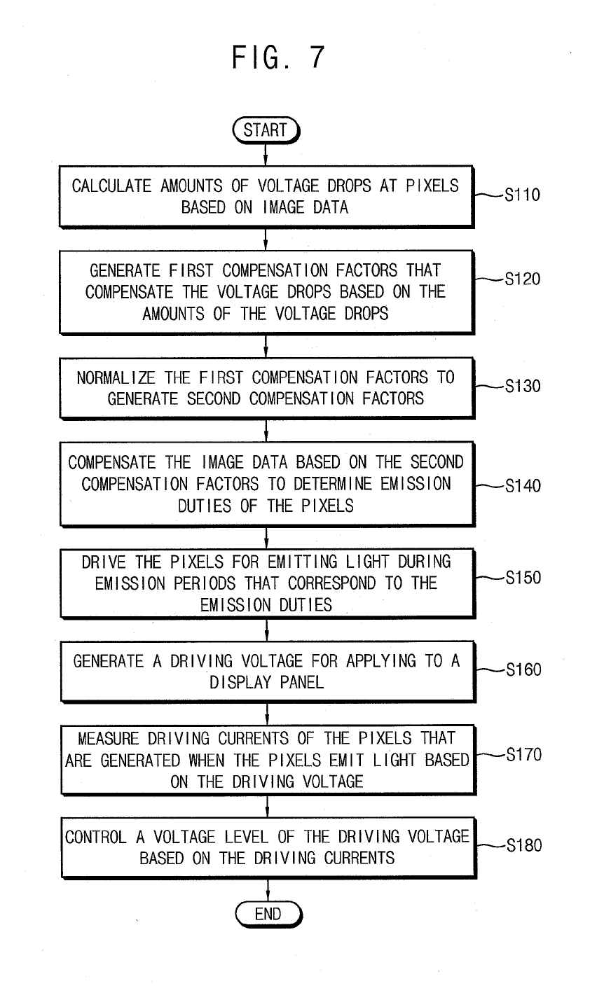

FIG. 7 is a flowchart illustrating a method of driving a display device according to example embodiments.

In some embodiments, the FIG. 7 procedure is implemented in a conventional programming language, such as C or C++ or another suitable programming language. The program can be stored on a computer accessible storage medium of the display device 100 or 200, for example, a memory (not shown) of the display device 100 or 200, the emission duty controller 140 or 240 or timing controller 376. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 7.

Referring to FIG. 7, the method of driving the display device including a plurality of pixels includes calculating amounts of voltage drops S110, generating first compensation factors S120, and generating second compensation factors S130. The method can also include determining emission duties of the pixels S140 and driving the pixels S150. The method can further include generating a driving voltage S160, measuring driving currents S170, and controlling a voltage level of the driving voltage S180.

The display device can calculate the amounts of the voltage drops at the pixels based on image data S110. The sum of the driving currents flowing into the display panel increases as panel load increases, so that the amounts of the voltage drops can increase. The amounts of the voltage drops at the pixels can be calculated based on the panel load and a resistance value which each of voltage supplying lines has.

The first compensation factors that compensate the voltage drops based on the amounts of the voltage drops can be generated S120. The driving currents can decrease as the driving voltage decreases. Thus, luminance of light emitted from the pixels can decrease. Therefore, the voltage drops can be compensated when the emission duties of the pixels are increased in response to decreased amount of the driving voltage. For example, the emission duty controller divides an original target luminance value by a luminance value that is decreased by the voltage drops to generate the first compensation factors.

The first compensation factors can be normalized to generate the second compensation factors S130. In some embodiments, the second compensation factors, which are results of dividing the first compensation factors by a maximum value of the first compensation factors, are generated. Here, a maximum value of the second compensation factors can be 1.

The image data can be compensated based on the second compensation factors to determine the emission duties of the pixels S140. For example, the image data is compensated when the emission duty controller multiplies the image data by the second compensation factors.

The pixels can be driven for emitting light during emission periods that correspond to the emission duties S150. The driving voltage can be generated for applying to the display panel S160. Also, the driving currents of the pixels can be measured, the driving currents being generated when the pixels emit light based on the driving voltage S170.

The voltage level of the driving voltage can be controlled based on the driving currents S180. For example, the sum of the measured driving currents and a targeted (or an expected) sum of the driving currents are compared, and the voltage level of the driving voltage is controlled based on the difference between the sum of the measured driving currents and the targeted sum of the driving currents.

As described above, the image data can be compensated based on the second compensation factors so that the luminance of light emitted from the pixels can be uniform. Moreover, in some embodiments, the first compensation factors are normalized so that color coordinates of emitted light are not distorted.

Although a few example embodiments of the display device and the method of driving the display device have been described with reference to the figures, those skilled in the art will readily appreciate that many modifications are possible in the example embodiments without materially departing from the novel teachings and advantages of the described technology.

The described technology can be applied to any electronic device including a display device. For example, the described technology can be applied to desktop computers, laptop computers, digital cameras, video camcorders, cellular phones, smartphones, smart pads, PMPs, PDAs, MP3 players, navigation systems, video phones, monitoring systems, tracking systems, motion detecting systems, image stabilization systems, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive technology. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel including a plurality of pixels;
an emission duty controller configured to i) calculate amounts of a plurality of voltage drops at the pixels based on image data, ii) generate a plurality of first compensation factors configured to respectively compensate the voltage drops, iii) normalize the first compensation factors so as to generate a plurality of second compensation factors, iv) compensate the image data based on the second compensation factors so as to determine a plurality of emission duties of the pixels, and v) drive the pixels so as to emit light during a plurality of emission periods respectively corresponding to the emission duties, wherein one of the emission periods and a non-emission period constitutes a frame period, and wherein each of the emission duties represents a ratio of the corresponding emission period to the corresponding frame period; and
a driving voltage controller configured to generate and apply a driving voltage to the display panel, measure a plurality of driving currents of the pixels when the pixels emit light based on the driving voltage, and control a voltage level of the driving voltage based on the driving currents.

2. The display device of claim 1, wherein the emission duty controller is further configured to divide the first compensation factors by a maximum value of the first compensation factors so as to generate the second compensation factors.

3. The display device of claim 1, wherein the emission duty controller includes:
a panel load calculator configured to calculate a panel load of the display panel based on the image data;
a voltage drop calculator configured to calculate the amounts of the voltage drops based on the panel load;
a compensation factor generator configured to generate the first compensation factors based on the amounts of the voltage drops and generate the second compensation factors based on the first compensation factors;
a compensator configured to compensate the image data based on the second compensation factors so as to determine the emission duties; and
a display panel driver configured to apply a plurality of data signals to the pixels, wherein the data signals are configured to control the emission periods based on the emission duties.

4. The display device of claim 3, wherein the driving voltage controller includes:
a target driving current calculator configured to calculate a target driving current based on the panel load, wherein the target driving current includes a targeted sum of the driving currents to be flowed into the pixels based on the panel load;
a driving current controller configured to measure the driving currents, calculate the sum of the driving currents of the pixels, and generate a driving voltage control signal based on the difference between the sum of driving currents and the target driving current; and
a voltage generator configured to i) generate and apply the driving voltage to the display panel and ii) control a voltage level of the driving voltage based on the driving voltage control signal.

5. The display device of claim 3, wherein the voltage drop calculator is further configured to calculate the amounts of the voltage drops based on the panel load and locations of the pixels.

6. The display device of claim 5, wherein the voltage drop calculator is further configured to calculate i) increased amounts of the voltage drops as the panel load increases and ii) decreased amounts of the voltage drops as the panel load decreases.

7. The display device of claim 3, wherein the compensation factor generator is further configured to increase the first compensation factors as the amounts of the voltage drops increase and decrease the first compensation factors as the amounts of the voltage drops decrease.

8. The display device of claim 3, wherein the compensation factor generator is further configured to generate the first compensation factors based on the amounts of the voltage drops and luminance of light emitted from the pixels.

9. The display device of claim 3, wherein the compensation factor generator is further configured to generate the first and second compensation factors every frame.

10. The display device of claim 3, wherein the compensation factor generator is further configured to calculate voltage differences between the driving voltage and the amounts of the voltage drops as applied voltages and calculate the first compensation factors based on the applied voltages.

11. The display device of claim 10, wherein the compensation factor generator includes:
an applied voltage calculator configured to calculate the applied voltages;
a first compensation factor generator configured to calculate the first compensation factors based on the applied voltages; and
a second compensation factor generator configured to normalize the first compensation factors so as to generate second compensation factors.

12. The display device of claim 3, wherein the compensator is further configured to multiply the image data by the second compensation factors so as to compensate the image data.

13. The display device of claim 3, further comprising a gamma generator configured to perform a gamma compensation of the image data based on a gamma curve.

14. The display device of claim 13, wherein the gamma generator includes:
a gamma register configured to store the gamma curve; and
a gamma compensator configured to read the gamma curve from the gamma register and compensate the image data based on the read gamma curve.

15. The display device of claim 3, wherein the display panel driver includes:
a scan driver configured to generate a plurality of scan signals; and
a data driver configured to generate the data signals, and
wherein the pixels are configured to receive the data signals while the scan signals are activated.

16. The display device of claim 15, further comprising a timing controller configured to control the display panel driver.

17. The display device of claim 4, wherein the target driving current calculator is further configured to generate a scale factor corresponding to the panel load based on a predetermined power control curve and apply the scale factor to the panel load so as to calculate the target driving current.

18. The display device of claim 17, wherein the target driving current calculator includes:
a memory configured to store the power control curve;
a scale factor generator configured to read the power control curve from the memory and generate the scale factor based on the power control curve; and
a scaler configured to apply the scale factor to the panel load to calculate the target driving current.

19. A method of driving a display device including a plurality of pixels, comprising:
calculating amounts of a plurality of voltage drops at the pixels based on image data;
generating a plurality of first compensation factors configured to respectively compensate the voltage drops based on the amounts of the voltage drops;
normalizing the first compensation factors so as to generate a plurality of second compensation factors;
compensating the image data based on the second compensation factors so as to determine a plurality of emission duties of the pixels;
driving the pixels so as to emit light during the emission periods, wherein one of the emission periods and a non-emission period constitute a frame period, and wherein each of the emission duties represents a ratio of the corresponding emission period to the corresponding frame period;
generating and applying a driving voltage to a display panel;
measuring driving currents of the pixels when the pixels emit light based on the driving voltage; and
controlling a voltage level of the driving voltage based on the driving currents.

20. The method of claim 19, wherein generating the second compensation factors includes dividing the first compensation factors by a maximum value of the first compensation factors.
